(19) United States
(12) Patent Application Publication
(10) Pub. No.: US 2025/0366693 A1
(43) Pub. Date: Dec. 4, 2025

(54) SURFACE CLEANING MACHINE COMPRISING A HOT FLUID GENERATING DEVICE AND METHOD FOR OPERATING A SURFACE CLEANING MACHINE

(71) Applicant: Alfred Kärcher SE & Co. KG, Winnenden (DE)

(72) Inventors: Tobias DUX, Winnenden (DE); Matthias HERDEN, Winnenden (DE); Christian KLEIN, Winnenden (DE); Fabian MOSER, Winnenden (DE); Thomas ROBIEU, Winnenden (DE); Michael SCHOENEWALD, Winnenden (DE); Frederic SOEHNER, Winnenden (DE)

(21) Appl. No.: 19/306,759

(22) Filed: Aug. 21, 2025

Related U.S. Application Data
(63) Continuation of application No. PCT/EP2024/054126, filed on Feb. 19, 2024.

(30) Foreign Application Priority Data
Feb. 24, 2023 (DE) 10 2023 104 615.2

(51) Int. Cl. A47L 11/40; A47L 11/30; B08B 1/16; B08B 1/20

(52) U.S. Cl. CPC A47L 11/4086; A47L 11/302; A47L 11/4016; A47L 11/4041; A47L 11/4069; A47L 11/4083; A47L 11/4088; B08B 1/165; B08B 1/20

(57) ABSTRACT

A surface cleaning machine is provided, including a cleaning head, at least one cleaning roller unit which is rotatably arranged at the cleaning head, a drive for driving a rotational movement of the cleaning roller unit, a hot fluid generating device which generates a hot fluid that is hot water with a temperature of at least 80° C. and/or steam, and at least one application chamber which is associated with the cleaning roller unit and which is operatively connected to the hot fluid generating device for fluid communication therewith, wherein, in operation, an interior space of the application chamber is filled with hot water mist and/or steam, wherein the application chamber has at least one opening, and wherein the cleaning roller unit is immersed in the interior space of the application chamber at the opening and, in operation, undergoes application of hot water mist and/or steam.

### CROSS-REFERENCE TO RELATED APPLICATIONS

This application is a continuation of international application number PCT/EP2024/054126, filed on Feb. 19, 2024, and claims the benefit of German application number 10 2023 104 615.2, filed on Feb. 24, 2023, which are incorporated herein by reference in their entirety and for all purposes.

### BACKGROUND OF THE INVENTION

The invention relates to a surface cleaning machine, comprising a cleaning head, at least one cleaning roller unit which is rotatably arranged at the cleaning head, and a drive for driving a rotational movement of the at least one cleaning roller unit.

The invention further relates to a method for operating a surface cleaning machine in which, in a cleaning mode of operation, a cleaning roller unit acts in rotation on a surface to be cleaned.

CN 218458058 U discloses a cleaning robot.

CN 216933041 U discloses a cleaning machine.

CN 202313129 U discloses a steam floor cleaning machine.

CN 202313125 U discloses a steam cleaning and dust removal machine.

US 2014/0208536 A1 discloses a steam vacuum cleaner having steam and vacuum cleaner functions combined in one machine.

EP 3 834 693 A1 discloses a surface cleaning apparatus with steam delivery system for steam mopping a floor surface after dry cleaning of the floor surface.

An apparatus under the designation “Tineco FLOOR ONE S5 STEAM”, comprising a steam cleaning function, is known in prior art.

Floor cleaning apparatus are described, for example, in EP 3 750 464 A1, EP 3 884 834 A1, US 2021/018620 A1 or KR 2012 06900U.

WO 2018/162092 A1 discloses a floor cleaning apparatus which enables autonomous cleaning of a floor surface to be performed.

Floor cleaning devices are also disclosed, for example, in EP 2 574 264 B1, U.S. Pat. No. 8,855,941 B1, DE 102 42 257 B4 and U.S. Pat. No. 10,149,589 B2.

DE 20 2015 101 302 U1 discloses a cleaning device in the form of a vacuum cleaner.

Surface cleaning machines are known from WO 2016/058901 A1, WO 2016/058856 A1, WO 2017/063663 A1, WO 2016/058879 A1, WO 2016/058956 A1. A surface cleaning machine is also known from WO 2016/058907 A1.

A portable floor cleaning apparatus is known from U.S. Pat. No. 4,875,246, which apparatus comprises a roller driven by an electric motor.

DE 20 2009 013 434 U1 discloses an apparatus for wet floor cleaning using a brush that is rotatable about an axis of rotation.

A cleaning machine is known from CN 201 197 698 Y.

An apparatus for cleaning floors or other hard surfaces is known from U.S. Pat. No. 6,026,529.

A surface cleaning machine with rotating brushes is known from WO 2010/041185 A1.

A cleaning head for a floor cleaning machine is known from U.S. Pat. No. 7,665,174 B2.

U.S. Pat. No. 4,173,054 discloses a floor cleaner, comprising a handle, a main body, a roller mechanism comprising a roller with a cleaning belt, a scraper and a dirty fluid receptacle.

WO 2013/106762 A2 discloses a surface cleaning machine, comprising a cleaning roller and a drive unit for driving the cleaning roller. A dirt tray is provided into which the cleaning roller sweeps dirt as it rotates. The dirt tray can be opened.

A floor scrubbing apparatus is known from U.S. Pat. No. 7,921,497 B2, which apparatus is manually operated and comprises a drive roller that is coupled to a scrub roller.

Another floor cleaning machine is disclosed in WO 2015/086083 A1.

U.S. Pat. No. 3,789,449 discloses a hard floor cleaning device.

DE 103 57 637 A1 discloses a self-propelled sweeping appliance, comprising a sweeping brush and an associated dirt collecting chamber.

DE 10 2007 054 500 A1 discloses a household floor cleaning appliance, comprising a wiping roller.

A floor cleaning device that comprises a housing, a hose assembly and a cleaning head is known from US 2006/0272120 A1.

A cleaning machine station for a cleaning machine is known from DE 10 2017 120 723 A1, wherein the cleaning machine station comprises a receiving chamber for a cleaning head of the cleaning machine.

WO 2005/087075 A1 discloses a floor cleaning machine, comprising a handle which is pivotably arranged on a base.

CN 107007215 A discloses a floor cleaning robot.

DE 20 2018 104 772 U1 discloses a dirty water collection and detection mechanism and a cleaning device.

Furthermore, cleaning machines are known from AU 2017101723 A4, CN 206687671 U, DE 20 2016 105 300 U1, U.S. Pat. No. 9,622,637 B1, CN 205359367 U, US 2017/0119225 A1, CN 205181250 U, CN 205181251 U, CN 205181256 U, DE 20 2016 105 299 U, WO 2017/059602 A1, WO2017/059600 A1, WO 2017/059601 A1, WO 2017/059603 A1 or DE 20 2016 105 301 U1.

### SUMMARY OF THE INVENTION

In accordance with an exemplary embodiment of the invention, a surface cleaning machine is provided with which surface cleaning can be performed in a hygienic manner.

In accordance with an exemplary embodiment of the invention, the surface cleaning machine comprises a cleaning head, at least one cleaning roller unit which is rotatably arranged at the cleaning head, and a drive for driving a rotational movement of the at least one cleaning roller unit, wherein a hot fluid generating device is provided which, in operation of the surface cleaning machine, generates a hot fluid, wherein the hot fluid is hot water with a temperature of at least 80° C. and/or steam, and wherein at least one application chamber is provided which is associated with the at least one cleaning roller unit and which is operatively connected to the hot fluid generating device for fluid communication therewith, wherein, in operation of the surface cleaning machine, an interior space of the at least one application chamber is filled with hot water mist and/or steam, wherein the at least one application chamber has at least one opening, and wherein the at least one cleaning roller unit is immersed in the interior space of the at least one application chamber at the at least one opening and, in operation of the surface cleaning machine, undergoes application of hot water mist and/or steam.

In the solution in accordance with the invention, the at least one cleaning roller unit is passed through the application chamber and undergoes application of hot water mist and/or steam therein.

In operation of the surface cleaning machine, the at least one cleaning roller unit is passed through a hot fluid atmosphere. On account of the rotation of the at least one cleaning roller unit and its immersion in the at least one application chamber, a particular area of the at least one cleaning roller unit is exposed to application of hot fluid over a relatively long period of time.

Hot fluid disinfection of the at least one cleaning roller unit is realized at the application chamber. It has been shown that bacteria in the order of 99.99% can thereby be removed.

In the floor cleaning machine in accordance with the invention, in-situ hot fluid disinfection of the at least one cleaning roller unit is realized in operation of the surface cleaning machine.

It is advantageous from a construction perspective for the at least one application chamber to be located at the cleaning head. Exposure of the at least one cleaning roller unit to a hot fluid atmosphere in the application chamber can thereby be achieved with simple structure.

It is advantageous for at least one of the following to be provided:
the at least one cleaning roller unit comprises at least one effective area for a surface to be cleaned, which effective area has, as an envelope, a substantially cylindrical outer surface, in particular wherein the cylindrical outer surface is coaxial with an axis of rotation of the at least one cleaning roller unit;
at least one area of immersion of the at least one cleaning roller unit into the at least one application chamber has, in cross-section, at least approximately the shape of a section of a circle or segment of a circle;
an axis of rotation of the at least one cleaning roller unit is parallel to a plane of support of the cleaning head on a surface to be cleaned;
the at least one opening has a direction of extent parallel to an axis of rotation of the at least one cleaning roller unit;
a direction of immersion of the at least one cleaning roller unit into the interior space of the at least one application chamber is perpendicular to an axis of rotation of the at least one cleaning roller unit.

This makes for a simple construction. The cleaning roller unit is exposed to a hot fluid atmosphere in the application chamber simultaneously over a relatively large areal extent thereof. As a result of this, effective hot fluid disinfection of the at least one cleaning roller unit is attained.

It is advantageous when, in operation of the surface cleaning machine, at least one of the following is provided:
the application of hot water mist and/or steam to the at least one cleaning roller unit is continuous;
a rotational speed of the at least one cleaning roller unit is in a range between 450 revolutions per minute and 500 revolutions per minute;
the application of hot water mist and/or steam to the at least one cleaning roller unit is over a range between 10% and 55% relative to a roller circumference, and in particular a range between 10% and 25% relative to the roller circumference;
a time over which a particular roller area of the at least one cleaning roller unit is exposed to the application of hot water mist and/or steam is in a range between 0.012 s and 0.06 s;
a temperature of the hot water mist and/or steam is in a range between 75° C. and 90° C. at contact with the at least one cleaning roller unit;
a temperature at the cleaning roller unit is in a range between 55° C. and 75° C. at contact with a surface to be cleaned.

Effective hot fluid disinfection of the at least one cleaning roller unit is achieved when one or more of the corresponding conditions are satisfied.

It is particularly advantageous for the at least one cleaning roller unit to be immersed with a partial effective area of an effective area thereof in the at least one application chamber, wherein the partial effective area is variable on account of rotation of the at least one cleaning roller unit in operation of the surface cleaning machine. Hot fluid can thereby be applied to a relatively large area of the at least one cleaning roller unit in order to thus achieve effective hot fluid disinfection. Furthermore, a particular area of the at least one cleaning roller unit is exposed to hot fluid in the application chamber for a relatively long duration of time in order to achieve an effective disinfecting action.

Furthermore, it is advantageous when, in operation of the surface cleaning machine, the at least one cleaning roller unit is immersed with a first partial effective area thereof in the at least one application chamber and acts on the surface to be cleaned with a second partial effective area thereof which is in spaced relation to the first partial effective area in a circumferential direction. This allows hot fluid disinfection of the at least one cleaning roller unit to be achieved simultaneously with a cleaning operation of the surface cleaning machine.

It is then further advantageous when, at a third partial effective area of the at least one cleaning roller unit which is in spaced relation to the first partial effective area in the circumferential direction and is in spaced relation to the second partial effective area in the circumferential direction, provision is made for loosening dirty fluid from the at least one cleaning roller unit. It is thereby possible that, in a “normal” cleaning operation in which the second partial effective area acts on the surface to be cleaned and loosening of dirty fluid for removal and incoupling thereof into a dirty fluid tank is realized at the third partial effective area, a hot fluid disinfection of the at least one cleaning roller unit can be carried out at the first partial effective area simultaneously therewith. On account of the rotation of the at least one cleaning roller unit, full exposure of the at least one cleaning roller unit (relative to a circumferential direction) to the hot fluid atmosphere in the application chamber is realized over a 360° rotation thereof.

It is further advantageous when at least one of the following exists:
the first partial effective area is located between the second partial effective area and the third partial effective area, with respect to a direction of rotation of the at least one cleaning roller unit;
a direction of rotation of the at least one cleaning roller unit is such that, upon rotation of the at least one cleaning roller unit, the first partial effective area transitions to the third partial effective area, or the first partial effective area transitions to the second partial effective area.

As a result, effective hot fluid disinfection with effective cleaning action is thereby achieved in operation of the surface cleaning machine. When the first partial effective area transitions to the third partial effective area, then the loosening of dirty fluid from the at least one cleaning roller unit is realized immediately after exposure to the hot fluid atmosphere. When the first partial effective area transitions to a second partial effective area, action of the at least one cleaning roller unit on the surface to be cleaned is realized immediately after disinfection by hot fluid.

It is advantageous when, relative to a longitudinal direction parallel to an axis of rotation of the at least one cleaning roller unit, at least 70% of an effective area, in particular at least 80%, in particular at least 90%, and in particular 100% of the effective area of the at least one cleaning roller unit is immersed in the at least one application chamber. A correspondingly effective hot fluid disinfection is thereby realized at the at least one cleaning roller unit.

It is advantageous when at least one of the following is provided:
the at least one application chamber forms an enclosure for a partial area of the at least one cleaning roller unit;
the at least one cleaning roller unit forms a movable cover for the at least one application chamber at the at least one opening;
in a 360° rotation of the at least one cleaning roller unit, an effective area of the at least one cleaning roller unit completes a full pass through the application chamber, with respect to a circumferential direction of the at least one cleaning roller unit.

By forming the at least one application chamber as an enclosure, in particular with the at least one cleaning roller unit as a movable cover, in operation (cleaning mode of operation) of the at least one cleaning roller unit, a large area thereof can be exposed to a hot fluid atmosphere over a correspondingly effectively prolonged period of time. The result is effective hot fluid disinfection without “disturbance” to the cleaning operation.

It is particularly advantageous for a sealing device to be provided which provides an operative fluid seal between the at least one cleaning roller unit and the at least one application chamber. Hot fluid disinfection of the at least one cleaning roller unit can thereby be achieved in an effective manner.

It is, in principle, provided that, in operation, the at least one application chamber is replenished with hot fluid so that, in particular, no substantial loss in respect of quantity of fluid and temperature occurs therein.

It is advantageous when at least one of the following to be provided:
the sealing device comprises a wall of the at least one application chamber, which wall is in contact against or protrudes into a cleaning substrate of the at least one cleaning roller unit;
the sealing device is arranged or formed at the at least one opening all therearound.

The sealing device can thereby be configured with simple structure. Cleaning operation is not hindered.

In an exemplary embodiment having simple structure, a wall of the at least one application chamber has, at the opening, a first longitudinal side, a second longitudinal side which is opposite the first longitudinal side, a first transverse side, and a second transverse side which is opposite the first transverse side, wherein the first transverse side and the second transverse side are each connected to the first longitudinal side and the second longitudinal side, with at least one of the following:
the first longitudinal side and/or the second longitudinal side are oriented parallel to an axis of rotation of the at least one cleaning roller unit;
the first longitudinal side and the second longitudinal side are parallel to one another;
the first transverse side and/or the second transverse side are oriented transversely, and in particular perpendicularly, to an axis of rotation of the at least one cleaning roller unit;
the first transverse side and the second transverse side are oriented parallel to one another;
the first longitudinal side and/or the second longitudinal side extends in a linear path along an end face thereof;
the first transverse side and/or the second transverse side extends in a curvilinear path, and in particular convexly curvilinear path, and in particular circular path, along an end face thereof.

This provides a simple way of immersing the at least one cleaning roller unit into the at least one application chamber at the opening thereof. Furthermore, a simple way is provided of forming a sealing device via the wall of the at least one application chamber.

By the corresponding geometric configuration of the longitudinal sides and the transverse sides (in particular the convexly curved course in the case of the transverse sides), the longitudinal sides and the transverse sides themselves can follow the course of the at least one cleaning roller unit. An effective sealing action can thereby be achieved between the at least one cleaning roller unit and the application chamber.

In an advantageous embodiment, the at least one application chamber has associated therewith a nozzle device for hot fluid which is, in particular, arranged at the at least one application chamber. The nozzle device provides, for example, for the formation of a mist of hot water in instances where hot water (prior to phase transition to steam) is used as the hot fluid. By way of the nozzle device, a homogeneous distribution of hot fluid can be achieved in the application chamber so that uniform application of hot fluid can be provided to the at least one cleaning roller unit over the entire surface area thereof that is immersed in the application chamber.

It is advantageous for a wetting device to be provided for wetting the at least one cleaning roller unit with cleaning liquid. By way of the wetted at least one cleaning roller unit, dirt present on a surface to be cleaned can be broken up and may be loosened from there when operating in cleaning mode.

In particular, the wetting device comprises the at least one application chamber. Generally, the at least one cleaning roller unit absorbs moisture by its exposure to a hot fluid atmosphere.

It is then advantageous for the wetting device to comprise at least one of the following:
an additional device, additionally to the at least one application chamber, which applies cleaning liquid to the at least one cleaning roller unit and/or to a surface to be cleaned;
a tank device for cleaning liquid;
a receptacle device for cleaning agent;
a nozzle device which is oriented towards the at least one cleaning roller unit and/or a surface to be cleaned and which is operatively connected to a tank device for cleaning liquid for fluid communication therewith.

By way of the additional device, additional wetting directly of the at least one cleaning roller unit or directly of the surface to be cleaned can be achieved. In particular, the dirt loosening capability can thereby be enhanced.

Improvement to the cleaning action can be achieved by providing a receptacle device for a cleaning agent, such as a surfactant cleaning agent. For example, it is then possible for a tank device for water which is provided for the hot fluid generating device to also be used for the additional wetting. (Generally, it is advantageous for cleaning agents, such as surfactant cleaning agents, to not be present in the generation of hot fluid. On the one hand, aerosol formation can thereby be avoided, and, on the other, it is generally advantageous for a hot fluid generator to operate on pure water, with no other added substance.)

By way of the nozzle device, effective application of cleaning liquid to the surface to be cleaned and/or the at least one cleaning roller unit can be achieved.

For a cleaning operation with simultaneous effective hot fluid disinfection of the at least one cleaning roller unit, it is advantageous when, in operation of the surface cleaning machine, upon rotation of the at least one cleaning roller unit, a particular area of the at least one cleaning roller unit (i) first undergoes application of cleaning liquid, is then passed through the at least one application chamber, and, thereafter, acts on the surface to be cleaned, or (ii) undergoes application of cleaning liquid, then acts on the surface to be cleaned, and, thereafter, is passed through the at least one application chamber.

It is particularly advantageous for at least one scraper to be provided which loosens dirty fluid from the at least one cleaning roller unit. Effective outcoupling of dirty fluid can thereby be achieved.

In particular, it is then advantageous for at least one of the following to be provided:
the at least one cleaning roller unit comprises a textile cleaning substrate and the at least one scraper is in contact against the cleaning substrate or protrudes into the cleaning substrate;
the at least one scraper is arranged or formed at the at least one application chamber;
the at least one scraper is configured as a scraper strip.

As a result, effective loosening of dirt from the at least one cleaning roller unit is thereby obtained.

A simple construction is made possible by the at least one scraper being arranged or formed at the at least one application chamber.

It is advantageous for the at least one scraper to be arranged, relative to a direction of rotation of the at least one cleaning roller unit, in such a way that (i) in operation of the surface cleaning machine, a particular area of the at least one cleaning roller unit first acts on the surface to be cleaned, then passes through the at least one application chamber, and, thereafter, rotates past the at least one scraper, or (ii) the particular area of the at least one cleaning roller unit is first passed through the application chamber, then acts on the surface to be cleaned, and is then passed past the at least one scraper. Effective cleaning action with simultaneous hot fluid disinfection of the at least one cleaning roller unit is thus obtained.

It is advantageous for at least one tank device for dirty fluid to be provided.

At least one of the following can then be provided:
the at least one tank device for dirty fluid is arranged at the cleaning head;
the at least one tank device for dirty fluid is removably arranged at the cleaning head;
dirty fluid is conveyed from the at least one cleaning roller unit to the at least one tank device for dirty fluid without using a fan or pump.

The corresponding surface cleaning machine can be configured such that it is simple in its construction, energy-efficient in its operation and that it comprises a low number of components. Dirty fluid loosened from the at least one cleaning roller unit is conveyed directly into the tank device for dirty fluid.

In an alternative exemplary embodiment, which can also be implemented in combination, a suction fan device comprising a suction fan is provided and/or a pump device comprising a pump is provided which conveys dirty fluid from the at least one cleaning roller unit to the tank device for dirty fluid. This can be advantageous for particular applications. For example, this then eliminates the need to arrange a tank device for dirty fluid at the cleaning head.

In an embodiment, the surface cleaning machine is configured as a machine that can be guided by an operator in a standing posture, wherein a holding rod device is provided which is arranged at the cleaning head, and is in particular articulated to the cleaning head. The surface cleaning machine is then a kind of wiping mop machine. In particular, such a surface cleaning machine is provided for cleaning floors, and hard floors in particular.

It is then advantageous when at least one of the following is provided:
the hot fluid generating device is arranged at the holding rod device;
a tank device for the hot fluid generating device is arranged at the holding rod device;
a tank device for cleaning liquid is arranged at the holding rod device;
a suction fan device for dirty fluid and/or a pump device for dirty fluid is arranged at the holding rod device.

In particular, this makes for a compact configuration of the cleaning head in order to, for example, enable the cleaning head to easily reach under furniture and the like.

Alternatively, it is possible for the surface cleaning machine to be configured as a self-propelled and self-steering machine (“cleaning robot”).

In particular, provision is made for the hot fluid generating device and the drive to be arranged at the cleaning head. The result is a correspondingly compact construction of the surface cleaning machine as a whole.

In an exemplary embodiment, the hot fluid generating device comprises a hot fluid generator and a pump. The hot fluid generator is, for example, a boiler (comprising a corresponding heating device) or a flow-through heater. The pump provides hot fluid conveyance, in particular for the supply of hot fluid from the hot fluid generating device to the application chamber. The pump, or another pump, can also be provided for the transport of pure water to the hot fluid generator. In principle, one or more valves can also be provided in order to correspondingly provide controllable release of the hot fluid supply to the application chamber.

Advantageously, the hot fluid generating device has associated therewith a tank device for water (pure water) in order to correspondingly generate hot fluid.

Here, a wetting device for applying cleaning liquid to the at least one cleaning roller unit and/or the surface to be cleaned can have associated therewith a tank device for cleaning liquid of its own, or the hot fluid generating device and the wetting device can have associated therewith a tank device for water which is common to both. In the latter case, the surface cleaning machine can have a lower number of components. In the former case, the tank device for cleaning liquid can also be filled with a cleaning liquid that has added thereto a cleaning agent, such as a surfactant cleaning agent.

It is, in principle, possible for the at least one cleaning roller unit to be of one-part or multi-part, in particular two-part, configuration. For example, a center drive of the at least one cleaning roller unit can be used where the cleaning roller unit is of two-part configuration.

It is also possible that exactly one cleaning roller unit or a plurality of cleaning roller units, and in particular exactly two cleaning roller units, are arranged at the cleaning head. For example, when exactly two cleaning roller units are arranged (which themselves can be of one-part or multi-part configuration), then the two cleaning roller units are in particular driven in counter-rotating directions when in operation.

In an embodiment, the at least one application chamber is arranged at the cleaning head, between a first cleaning roller unit and a second cleaning roller unit. This makes for a space conserving construction. Here, one application chamber can be provided for each cleaning roller unit, or a common chamber can be provided for both the first cleaning roller unit and the second cleaning roller unit.

In a compact configuration of the cleaning head, the cleaning head has a front end, relative to a forward travel direction of the surface cleaning machine, and the at least one application chamber is arranged at the front end. Thereby, a tank device for dirty fluid can also be arranged at the cleaning head, in particular in a space conserving manner.

In particular, the at least one cleaning roller unit is arranged at the cleaning head, between the at least one application chamber and a tank device for dirty fluid. This makes for a compact construction.

In accordance with an exemplary embodiment of the invention, a method is provided for operating a surface cleaning machine, and in particular a surface cleaning machine in accordance with the invention, in which, in a cleaning mode of operation, a cleaning roller unit acts in rotation on a surface to be cleaned, and in which method the cleaning roller unit is passed through an application chamber to which hot water mist or steam is applied.

Hot fluid disinfection of the cleaning roller unit can thereby be achieved simultaneously with the cleaning operation.

The advantages of the method in accordance with the invention have already been discussed in relation to the surface cleaning machine in accordance with the invention.

Further advantageous embodiments of the method in accordance with the invention have already been discussed in relation to the floor cleaning machine in accordance with the invention.

In particular, the method in accordance with the invention can be performed on the surface cleaning machine in accordance with the invention, or the surface cleaning machine in accordance with the invention can be operated using the method in accordance with the invention.

It is particularly advantageous when, in operation of the surface cleaning machine, at least one of the following is provided:
the application of hot water mist and/or steam to the at least one cleaning roller unit is continuous;
a rotational speed of the at least one cleaning roller unit is in a range between 450 revolutions per minute and 500 revolutions per minute;
the application of hot water mist and/or steam to the at least one cleaning roller unit is over a range between 10% and 55% relative to a roller circumference, and in particular a range between 10% and 25% relative to the roller circumference;
a time over which a particular roller area of the at least one cleaning roller unit is exposed to the application of hot water mist and/or steam is in a range between 0.012 s and 0.06 s;
a temperature of the hot water mist and/or steam is in a range between 75° C. and 90° C. at contact with the at least one cleaning roller unit;
a temperature at the cleaning roller unit is in a range between 55° C. and 75° C. at contact with a surface to be cleaned.

Thereby, effective hot fluid disinfection of the cleaning roller unit can be achieved.

In particular, it is then advantageous when one and preferably more than one, and more preferably all, of the above conditions are satisfied.

In particular, it is advantageous for a first partial effective area of the cleaning roller unit to be positioned in the application chamber when a second partial effective area of the cleaning roller unit acts on the surface to be cleaned, wherein the second partial effective area is in spaced relation to the first partial effective area in a circumferential direction (relative to an axis of rotation of the cleaning roller unit). Hot fluid disinfection of the cleaning roller unit can thereby be achieved simultaneously with the cleaning operation.

It is then further advantageous when, at a third partial effective area of the cleaning roller unit, dirty fluid is loosened from the cleaning roller unit, wherein the third partial effective area is in spaced relation to the first partial effective area in the circumferential direction and is in spaced relation to the second partial effective area in the circumferential direction. This makes for an effective cleaning operation. The cleaning roller unit, at the second partial effective area thereof, acts upon the surface to be cleaned, and loosening of dirty fluid is realized at the third partial effective area simultaneously therewith.

Provision can be made for the cleaning roller unit to rotate in a direction of rotation such that a particular area of the cleaning roller unit is first passed through the application chamber, then acts on the surface to be cleaned, and, thereafter, loosening of dirty fluid is realized at the particular area. Alternatively, the cleaning roller unit rotates in a direction of rotation such that a particular area of the cleaning roller unit first acts on the surface to be cleaned, is then passed through the application chamber, and, thereafter, loosening of dirty fluid is realized at the particular area. In both cases, hot fluid disinfection of the cleaning roller unit can be performed synchronously with the cleaning operation.

It is advantageous for the cleaning roller unit to be wetted, wherein the wetting is realized in the application chamber by use of hot water fluid and/or steam, and, in particular, additional wetting is realized by use of cleaning liquid from a tank device for cleaning liquid. Effective dirt loosening can thereby be achieved when operating in cleaning mode.

It is particularly advantageous for the application chamber to be replenished with hot fluid. Losses of hot fluid occur by the cleaning roller unit going through hot fluid application in the application chamber, wherein the corresponding application area then rotates out of the application chamber. These losses are compensated for by replenishing the application chamber with hot fluid. In particular, the replenishing is carried out such that a hot fluid atmosphere will form in the application chamber that remains constant over time, in the sense of equilibrium of flow. Effective hot fluid disinfection of the cleaning roller unit can thereby be achieved. In principle, the replenishment can be continuous, or can be at intervals of time, and, for example, pulsed.

The following description of preferred embodiments serves in conjunction with the drawings to explain the invention in greater detail.

### BRIEF DESCRIPTION OF THE DRAWINGS

FIG. 1 shows a schematic block diagram representation illustrating the structure of an exemplary embodiment of a surface cleaning machine in accordance with the invention;

FIG. 2 shows a schematic block diagram representation of another exemplary embodiment of a surface cleaning machine in accordance with the invention;

FIG. 3 shows a partial view of an exemplary embodiment of a surface cleaning machine in accordance with the invention, comprising a cleaning roller unit and an application chamber;

FIG. 4 shows a plan view in direction A of FIG. 3 for an exemplary embodiment that comprises a one-part cleaning roller unit;

FIG. 5 shows a view similar to that of FIG. 4, illustrating an exemplary embodiment that comprises a two-part cleaning roller unit;

FIG. 6 shows a schematic partial representation of another exemplary embodiment of a surface cleaning machine in accordance with the invention, comprising a first cleaning roller unit, an application chamber and a second cleaning roller unit;

FIG. 7 shows a top plan view of the arrangement in direction B of FIG. 6, wherein the first cleaning roller unit and the second cleaning roller unit are each of a one-part configuration;

FIG. 8 shows a view similar to that of FIG. 7, illustrating a variant in which the first cleaning roller unit and the second cleaning roller unit are each of a two-part configuration;

FIG. 9 schematically illustrates, as an exemplary embodiment of a surface cleaning machine, an exemplary embodiment of a floor cleaning machine for operation by a user in a standing posture;

FIG. 10 shows a schematic representation of another exemplary embodiment of a floor cleaning machine, which is in particular of self-propelled and self-steering configuration; and

FIG. 11 shows a further exemplary embodiment of a floor cleaning machine.

### DETAILED DESCRIPTION OF THE INVENTION

A surface cleaning machine in accordance with the invention finds particular use in cleaning hard surfaces or smooth surfaces. For example, a surface cleaning machine in accordance with the invention is configured as a floor cleaning machine, or is used as such, in order to clean (hard) floors.

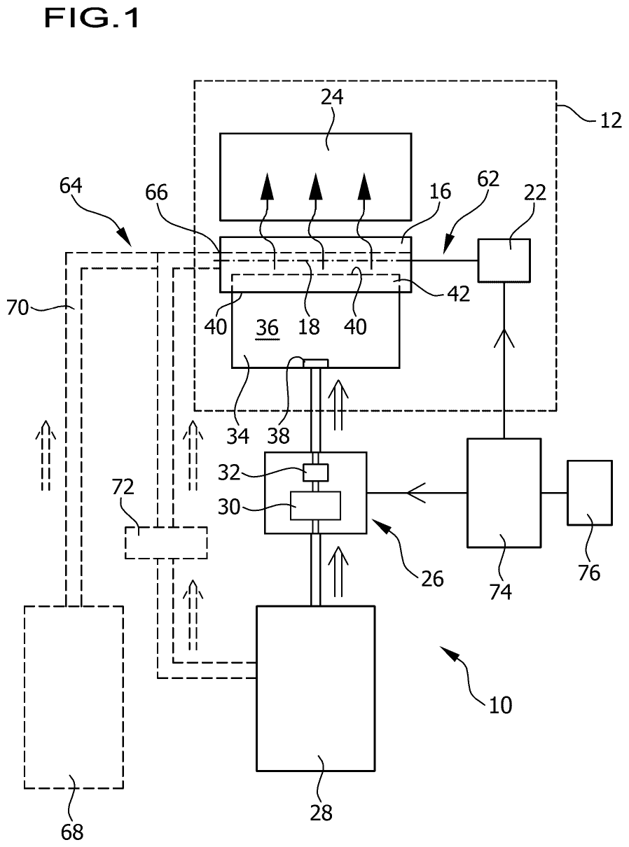

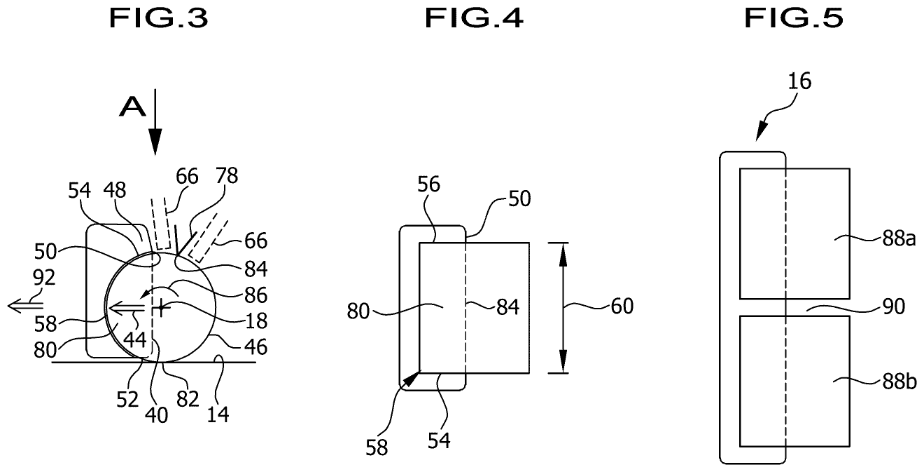

A first exemplary embodiment of a surface cleaning machine in accordance with the invention, schematically shown in FIG. 1 in block diagram form and designated therein by the reference numeral 10, comprises a cleaning head 12. In a cleaning mode of operation, the surface cleaning machine 10 acts on a surface 14 to be cleaned via the cleaning head 12 (FIGS. 3, 6, 9 to 11).

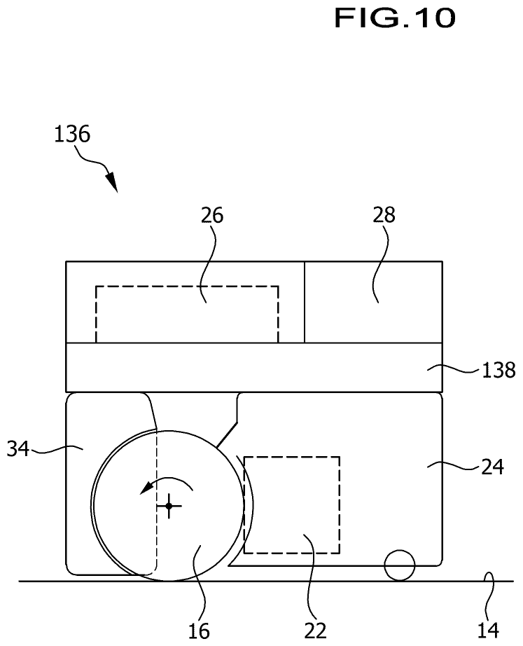

Essential functional components of the surface cleaning machine 10 are arranged at the cleaning head 12. In an embodiment of a self-propelled and self-steering cleaning machine (“cleaning robot”), even all the functional components are arranged at the cleaning head 12 (cf. FIG. 10).

Located at the cleaning head 12 is (at least) one cleaning roller unit 16. The cleaning roller unit 16 is supported on the cleaning head 12 for rotation about an axis of rotation 18.

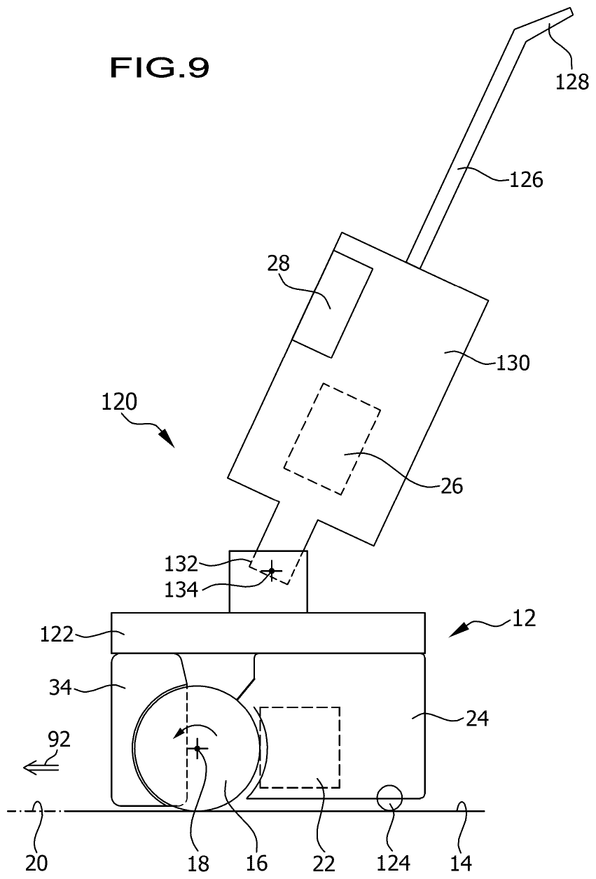

In an exemplary embodiment, provision is made for a plane of support 20 (cf. FIG. 9, for example) of the cleaning head 12 on the surface 14 to be cleaned is parallel to the axis of rotation 18. (In the case of a planar surface 14 to be cleaned, the geometric plane of support 20 is coincident with the surface 14 to be cleaned.) The plane of support 20 is defined by way of the cleaning roller unit 16.

In an exemplary embodiment, when in a cleaning mode of operation, the cleaning head 12 is supported via one single cleaning roller unit 16 alone, which cleaning roller unit 16 then alone defines the plane of support 20.

In another exemplary embodiment, when in a cleaning mode of operation, the cleaning head 12 is supported on the surface 14 to be cleaned via the cleaning roller unit 16 and one or more support elements. Such a support element can itself be a cleaning roller unit or, for example, a support roller, a skid, and so forth. In this case, the plane of support 20 is defined by the cleaning roller unit 16 and by the one or more additional support elements.

The cleaning roller unit 16 has a one-part construction (cf. FIGS. 4 and 7), or it has a multi-part construction (cf. FIGS. 5 and 8), and, then, a two-part construction in particular. In particular, where the cleaning roller unit 16 is made up of a multi-part construction, all roller parts rotate synchronously about the same axis of rotation 18, and, in particular, a drive is provided for a one-part or a multi-part cleaning roller unit 16 which drives the cleaning roller unit 16 as a whole in its rotational movement about the axis of rotation 18.

In an exemplary embodiment, the cleaning roller unit 16 comprises a holder, for example a cylindrical holder, at which a cleaning substrate, such as, for example, a textile cleaning substrate, is arranged. The cleaning substrate acts on the surface 14 to be cleaned during the cleaning operation.

Associated with the cleaning roller unit 16 is a drive 22. In particular, the drive 22 is or comprises a motor drive, and preferably an electric motor. In particular, a gearing device is arranged between the corresponding motor (electric motor) and the cleaning roller unit 16. The gearing device provides speed transmission and torque transmission over a corresponding distance.

In an exemplary embodiment, the drive 22 is arranged at, and in particular in, the cleaning head 12. For example, the drive 22 can be arranged beside, behind or above the cleaning roller unit 16 at the cleaning head 12. In an embodiment, the drive 22 is arranged as an internal drive at which the cleaning roller unit 16 is located.

In another exemplary embodiment, the motor drive of the drive 22 is located, for example, at a holding rod device which is articulated to the cleaning head 12 (see, for example, WO 2016/058879 A1).

A tank device 24 for dirty fluid is associated with the cleaning roller unit 16. The tank device 24 receives dirty fluid loosened from the cleaning roller unit 16. The dirty fluid is in particular a mixture of liquid (primarily water) and dirt particles.

In an exemplary embodiment, the tank device 24 for dirty fluid is releasably arranged at the cleaning head 12. In particular, dirty fluid loosened from the cleaning roller unit 16 is conveyed into the tank device 24 without using a fan or pump.

Usually, provision is made for only the tank device 24 for dirty fluid to be present. It is, in principle, also possible for dirty fluid to be conveyed from one or more tanks that are located at the cleaning head 12 into another tank of the tank device 24, for example by using a pump or a suction fan.

The surface cleaning machine 10 comprises a hot fluid generating device 26. The hot fluid generating device 26 in an exemplary embodiment can be arranged at the cleaning head 12. It can also be arranged externally to the cleaning head 12, such as at a holding rod device for example.

The hot fluid generating device 26 generates a hot fluid from water. As used herein, hot fluid refers to hot water (without phase change) and steam (with phase change). Here, the hot fluid generating device 26 is configured such that, when it is utilized to generate hot water, the hot water has a temperature of at least 80° C.

The hot fluid generated is provided to the cleaning head 12 by the hot fluid generating device 26.

The surface cleaning machine 10 comprises a tank device 28 for water. The tank device 28 is operatively connected to the hot fluid generating device 26 for fluid communication therewith. Water is provided from the tank device 28 to the hot fluid generating device 26 for generating hot fluid.

The tank device 28 is arranged at the cleaning head 12 or at a holding rod device. It is, in principle, also possible, for example, for the tank device 28 to be an external tank device which, for example, can be a travelling tank device which is guided over the surface 14 to be cleaned, or which, for example, is carried by a user.

The hot fluid generating device 26 comprises a hot fluid generator. In particular, the hot fluid generator is a boiler or a flow-through heater which, correspondingly, heats up water provided from the tank device 28 in order to produce steam, or to produce hot water before liquid-to-steam phase change, in particular hot water with a temperature of at least 80° C. The hot fluid generator is indicated by the reference numeral 30 in FIG. 1.

In an exemplary embodiment, the hot fluid generating device 26 also comprises a pump 32 in order to provide fluid conveyance at the hot fluid generating device 26.

The hot fluid generating device 26 also comprises one or more valves, these being controlled valves in particular. Hot fluid can be specifically delivered from the hot fluid generating device 26 via said valves.

An application chamber 34 is arranged at the cleaning head 12. Here, the application chamber 34 is associated with the cleaning roller unit 16. The application chamber 34 has an interior space 36 and is operatively connected to the hot fluid generating device 26 for fluid communication therewith. Hot fluid produced and provided by the hot fluid generating device 26 can be incoupled into the interior space 36 of the application chamber 34.

In an exemplary embodiment, a nozzle device 38 is located at the application chamber 34, which nozzle device 38 serves to distribute the hot fluid in the interior space 36.

In particular, where hot water is used as the hot fluid, the nozzle device 38 is configured such that it also provides nebulization of the hot fluid so that, in operation of the surface cleaning machine 10, a hot fluid mist exists in the interior space 36.

Where steam is used as the hot fluid, the nozzle device 38 provides for a corresponding steam filling, and homogeneous steam filling in particular, of the interior space 36 in operation of the surface cleaning machine 10.

The application chamber 34 comprises (at least) one opening 40 (cf. FIG. 3) which faces towards the associated cleaning roller unit 16.

A partial area 42 of the cleaning roller unit 16 is immersed in the interior space 36 of the application chamber 34 via said opening 40. In operation of the surface cleaning machine, the partial area 42 immersed in the interior space 36 is exposed to the hot fluid atmosphere (hot water mist or steam atmosphere). Correspondingly, hot fluid application to the partial area 42, and to a cleaning substrate at the partial area 42 of the cleaning roller unit 16 in particular, is realized in the interior space 36.

The cleaning roller unit 16 is immersed with its partial area 42 in the application chamber 34 through the opening 40. A direction of immersion 44 in which the cleaning roller unit 16 is immersed in the interior space 36 is perpendicular to the axis of rotation 18 (cf. FIG. 3).

The at least one cleaning roller unit 16 has an effective area 46 for the surface 14 to be cleaned. The effective area 46 is the part of the cleaning roller unit 16 with which the latter acts on the surface 14 to be cleaned.

In an exemplary embodiment, the effective area 46 is formed by a cleaning substrate, and a textile cleaning substrate in particular.

The effective area 46 has, as an envelope, a substantially cylindrical outer surface. Generally, when the cleaning roller unit 16 is placed on the surface 14 to be cleaned and as the weight of the surface cleaning machine 10 is acting thereupon, the cleaning roller unit 16, and the effective area 46 thereof in particular, is correspondingly deformed. In that case, the envelope is not exactly a cylindrical outer surface but corresponds to the outer surface of a flattened cylinder.

The opening 40 conforms to the cylindrical shape of the effective area 46. The application chamber 34 forms an enclosure for the partial area 42 of the cleaning roller unit 16. The cleaning roller unit 16 itself forms a cover at the opening 40, wherein said cover is movable on account of the rotation of the cleaning roller unit 16 about the axis of rotation.

In an exemplary embodiment, the application chamber 34 comprises a wall 48 which correspondingly conforms to the cylindrical shape of the cleaning roller unit 16.

At the opening 40, the wall 48 has a first longitudinal side 50 and a second longitudinal side 52 opposite the first longitudinal side (FIGS. 3, 4). The first longitudinal side 50 and the second longitudinal side 52 are in spaced relation to one another in a direction perpendicular to the axis of rotation 18 and perpendicular to the plane of support 20.

In an exemplary embodiment, the first longitudinal side 50 and the second longitudinal side 52 have a configuration that conforms to the cylindrical envelope of the cleaning roller unit 16, and have a linear shape in particular.

Furthermore, the wall 48 has a first transverse side 54 and a second transverse side 56 opposite the first transverse side. The first transverse side 54 and the second transverse side 56 are in spaced relation to one another in a direction parallel to the axis of rotation 18. The first transverse side 54 and the second transverse side 56 each connect the first longitudinal side 50 and the second longitudinal side 52 to one another.

At the opening 40, the first transverse side 54 and the second transverse side 56 of the wall 48 conform to the (approximately) cylindrical outer surface of the cleaning roller unit 16 at the effective area 46 thereof. Correspondingly, they have a convexly curved shape, and have a circular-shaped configuration in particular.

A sealing device 58 is provided between the application chamber 34 and the cleaning roller unit 16. The sealing device 58 provides a fluid-tight seal, so that, as mentioned above, the cleaning roller unit 16 can form a cover of the interior space 36. The sealing device 58 is for providing sufficient hot fluid application to the effective area 46 of the cleaning roller unit 16 in the interior space 36 of the application chamber 34 when the surface cleaning machine 10 is in operation.

In an exemplary embodiment, the sealing device 58 is formed by the wall 48 and, in particular, by an end face region of the wall 48 that is associated with the cleaning roller unit 16.

Correspondingly, the wall 48, at the first longitudinal side 50, the second longitudinal side 52, the first transverse side 54, and the second transverse side 56 thereof, is in contact against the effective area 46 of the cleaning roller unit 16 or projects thereinto in order to achieve a fluid-tight seal as mentioned above.

The partial area 42 with which the cleaning roller unit 16 is immersed in the application chamber 34 at the opening 40 has a length 60 (cf. FIG. 4) along the axis of rotation 18 which, in particular, is at least 70% of the effective area 46 of the cleaning roller unit 16. In the exemplary embodiment shown, with respect to the direction parallel to the axis of rotation 18, the cleaning roller unit 16 is completely immersed with the corresponding effective area 46 in the interior space 36, relative to the length 60.

In operation of the surface cleaning machine 10, the application chamber 34 has a hot fluid applied thereto, and here, in particular, hot water mist and/or steam. This in turn is applied to the corresponding effective area 46 of the cleaning roller unit 16. The cleaning roller unit 16 is thereby disinfected and wetted simultaneously. The cleaning roller unit 16, and in particular the corresponding effective area 46 thereof, such as for example a textile cleaning substrate, takes up moisture, which moisture can serve to enhance the cleaning operation. In an embodiment, provision can be made for a corresponding wetting device 62 for the cleaning roller unit 16 to be then formed by way of the application chamber 34 and the hot fluid generating device 26.

In an exemplary embodiment, the wetting device 62 comprises an additional device 64 by way of which cleaning liquid is supplied to the cleaning roller unit 16 and/or to the surface 14 to be cleaned.

To this end, a nozzle device 66 is provided, which nozzle device 66 is arranged and configured such that, via the nozzle device 66, cleaning liquid is applied to the cleaning roller unit 16 exteriorly of the application chamber 34 and/or is directly applied to the surface 14 to be cleaned.

The cleaning liquid which can be applied to the cleaning roller unit 16 and/or to the surface 14 to be cleaned by way of the additional device 64 can be pure water or water comprising a cleaning agent (in particular a surfactant cleaning agent) as an additive.

In an exemplary embodiment, a tank device 68 for cleaning liquid is provided. The tank device 68 is arranged, for example, at the cleaning head 12 or at the holding rod device. The tank device 68 can hold cleaning liquid including a cleaning agent (such as a surfactant cleaning agent). Cleaning liquid is supplied to the nozzle device 66 via a corresponding conduit device 70.

Here, in particular, the cleaning liquid is supplied in a controlled manner, for example via a valve device. Here, for example, the valve device is controlled such that it releases the flow of liquid to the nozzle device 66 when the surface cleaning machine is turned on for a cleaning operation.

It is, in principle, also possible for the tank device 28 serving to hold water therein to be used for the additional device 64. The tank device 28 provides water to the hot fluid generating device 26. Therefore, the tank device should contain no cleaning agent, and should contain no surfactant cleaning agent in particular, because this can cause unwanted aerosol formation in the generation of hot fluid.

In this case, a receptacle device 72 can be provided, which receives cleaning agent and which is arranged between the nozzle device 66 and the tank device 28 (relative to the flow path).

The surface cleaning machine 10 comprises a control device 74. In particular, the control device 74 controls the drive 22 and also the hot fluid generating device 26.

An energy supply device 76 is provided which supplies electrical energy to corresponding components of the surface cleaning machine 10. Energy can be supplied, for example, from the mains power supply or through battery power.

At least one scraper 78 is provided to loosen dirty fluid from the cleaning roller unit 16 (cf. FIG. 3). The scraper 78 acts upon the effective area 46 and is in contact thereagainst or protrudes thereinto (is in contact against or protrudes into a textile cleaning substrate in particular) and scrapes dirty fluid (liquid and dirt particles) off the cleaning roller unit 16. Thence, the dirty fluid is conveyed into the tank device 24 without using a fan or pump, as has been mentioned above. In particular, the scraper 78 is arranged above the plane of support 20, relative to the plane of support 20. Under the normally intended conditions of use of the surface cleaning machine 10 in which the cleaning head 12 is supported, via the plane of support 20, on the surface 14 to be cleaned, the scraper 78 is located, relative to the direction of gravity, above the plane of support 20 and also above the cleaning roller unit 16 (while contacting same or protruding thereinto as mentioned above).

Here, when the nozzle device 66 of the additional device 64 is used to apply cleaning liquid to the cleaning roller unit 16, provision can be made for said nozzle device 66 to be arranged between the scraper 78 and the application chamber 34, or to be arranged on a side of the scraper 78 facing away from the application chamber 34. Both such options are indicated in FIG. 3.

In the first option, the additional wetting is realized immediately before dirty fluid is scraped off. In the second option, the additional wetting is realized after dirty fluid is scraped from the cleaning roller unit 16.

In the surface cleaning machine 10, the effective area 46 has—in a “point-in-time snapshot”—a first partial area, namely a first partial effective area 80 which is immersed in the application chamber 34. The effective area 46 has a second partial effective area 82 with which the cleaning roller unit 16 acts on the surface 14 to be cleaned and with which it is placed on the surface 14 to be cleaned.

The effective area 46 further has a third partial effective area 84 at which dirty fluid is loosened via the scraper 78.

The partial effective areas 80, 82, 84 are variable and transition one to the other by the rotation of the cleaning roller unit 16 about the axis of rotation 18.

The second partial effective area 82 is in spaced relation to the first partial effective area 80 in a circumferential direction (with respect to the axis of rotation 18). The third partial effective area 84 is in spaced relation to the second partial effective area 82 in a circumferential direction. The third partial effective area 84 is also in spaced relation to the first partial effective area 80 in a circumferential direction. The partial effective areas succeed each other in the circumferential direction.

In a 360° rotation of the cleaning roller unit 16, the effective area 46 makes a full pass (relative to the circumferential direction) through the application chamber 34.

In the exemplary embodiment as shown, the effective area 46 also makes a full pass through the application chamber 34 relative to its length 60.

In this exemplary embodiment, then, the entire surface area of the effective area 46 goes through application of hot fluid at the application chamber 34.

It is, in principle, possible for the cleaning roller unit 16 to rotate about the axis of rotation 18 in a direction of rotation 86 in which the first partial effective area 80 first becomes a second partial effective area 82 and then a third partial effective area 84. This means that a particular area at the effective area 46 of the cleaning roller unit 16 first experiences application of hot fluid at the application chamber 34, then acts on the surface 14 to be cleaned, followed by loosening of dirty fluid at that area via the scraper 78.

Here, with respect to that direction of rotation 86, the supply of additional cleaning liquid can be realized before dirty fluid is scraped off by the scraper 78, or after that but prior to re-entrance into the application chamber 34.

In principle, a reverse direction of rotation 86 is also possible, as will be explained in greater detail hereinbelow.

In FIGS. 3 and 4, the cleaning roller unit 16 is shown as having a one-part configuration.

It is also possible for the cleaning roller unit 16 to be made up of multi-part configuration (cf. FIG. 5). In this case, the cleaning roller unit 16 is made up of several, and in particular two, parts 88a, 88b, having respective effective areas. The parts 88a and 88b are spaced apart from one another. A center drive is possible via a corresponding center area 90.

The surface cleaning machine 10 in accordance with the invention works as follows:

In operation of the surface cleaning machine 10, hot fluid is generated at the hot fluid generating device 26. Water from the tank device 28 is used for that purpose. The hot fluid is incoupled into the application chamber 34. A hot water mist or a steam atmosphere forms in the application chamber 34.

Here, the application chamber 34 is constantly replenished with hot fluid by the hot fluid generating device 26. The replenishment can be continuous or, for example, pulsed. In particular, the replenishment is controlled via the control device 74.

In a cleaning mode of operation of the surface cleaning machine 10, the cleaning roller unit 16 rotates about the axis of rotation 18. When placed on the surface 14 to be cleaned, the cleaning roller unit 16 acts on the surface 14 to be cleaned via the second partial effective area 82.

By the application of hot water mist or steam to the cleaning roller unit 16 in the application chamber 34, a part of the cleaning roller unit 16 (the first partial effective area 80) is disinfected. The hot fluid or steam provides effective killing of bacteria.

A particular line region of the effective area 46 is exposed to the hot fluid application during the time of passage through the interior space 36 upon rotation of the axis of rotation 18, and, correspondingly, effective disinfection is realized.

The surface cleaning machine 10 is operated such that a rotational speed of the cleaning roller unit 16 is preferably in a range between 450 revolutions per minute and 500 revolutions per minute.

The application chamber 34 is of a size such that hot fluid or steam is applied simultaneously to an area of the cleaning roller unit 16 that is in a range between 10% and 55% relative to a roller circumference of the cleaning roller unit 16, and is in particular in a range between 10% and 25%. The remaining portion of the cleaning roller unit 16 is then located outside the application chamber 34.

Furthermore, it is preferably provided that a time over which the cleaning roller unit 16 is exposed to the application of hot water mist or steam is in a range between 0.012 s and 0.06 s.

Furthermore, it is in particular provided that a temperature of the hot fluid or steam (the hot water mist or steam) is in a range between 75° C. and 90° C. at contact with the cleaning roller unit 16.

Furthermore, it is in particular provided that a temperature at the cleaning roller unit 16 is in a range between 55° C. and 75° C. at contact with a surface 14 to be cleaned.

In the exemplary embodiment of FIGS. 3 to 5, along the corresponding direction of rotation 86, a particular area of the effective area 46 is then, after passage through the application chamber 34, transitioned as the second partial effective area 82 onto the surface 14 to be cleaned (on account of the rotation of the cleaning roller unit 16). It loosens dirt from there and picks up dirty fluid. Continued rotation then causes dirty fluid to be loosened at the scraper 78 and conveyed to the tank device 24.

In principle, the cleaning roller unit 16 is wetted at the first partial effective area 80 thereof as it is rotated through the application chamber 34.

In an embodiment, an additional device 64 is provided for the wetting of the cleaning roller unit 16, which additional device 64 provides additional wetting to the cleaning roller unit 16 in order to improve the latter's capability of loosening dirt from the surface 14 to be cleaned.

By way of the hot fluid generating device 26 and the application chamber 34, hot fluid disinfection of the cleaning roller unit 16 is realized during passage of the corresponding partial area 42 of the cleaning roller unit 16.

The sealing device 58 provides for minimizing “short circuit flows” of hot fluid.

In an exemplary embodiment, the surface cleaning machine 10 has a forward travel direction 92 (FIG. 3). In an exemplary embodiment, the application chamber 34 is arranged ahead of the cleaning roller unit 16 relative to the forward travel direction 92. The cleaning roller unit 16 is arranged between the application chamber 34 and the tank device 24 for dirty fluid.

It is also possible, for example, for the application chamber 34 (and the tank device 24) to be arranged behind the cleaning roller unit 16 with respect to the forward travel direction 92.

In principle, it is also possible to provide for hot fluid or steam to be additionally applied directly onto the surface 14 to be cleaned via a corresponding nozzle device.

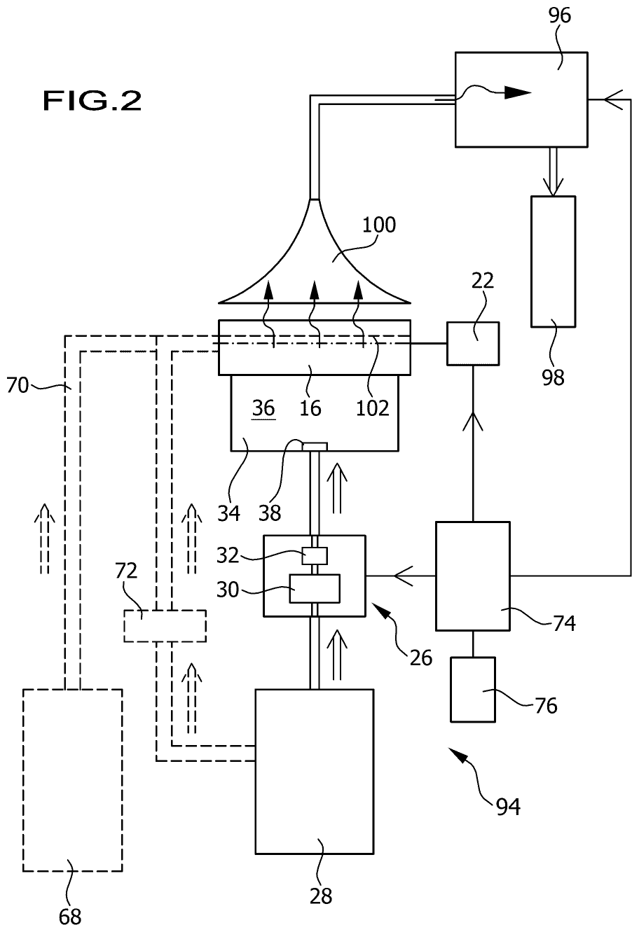

In a further exemplary embodiment of a surface cleaning machine in accordance with the invention, schematically shown in FIG. 2 in block diagram representational form, a suction fan device 96 is provided. The suction fan device 96 comprises a suction fan with a suction fan motor. Associated with the suction fan device 96 is a tank device 98 for dirty fluid. Further associated with the suction fan device 96 is a separator which can be integrated in the tank device 98. The separator serves the purpose of separating air and dirty fluid.

In particular, the suction fan device 96 and the tank device 98 are arranged at a holding device.

A nozzle device 100 is provided, which nozzle device 100 is a suction nozzle device. The nozzle device 100 is associated with the cleaning roller unit 16. A suction flow is generated via the suction fan device 96, which suction flow acts on the cleaning roller unit 16 via the nozzle device 100. At least one scraper 102 is provided, which scraper 102 scrapes dirty fluid off the cleaning roller unit 16. The nozzle device 100 is oriented towards the scraper 102, and dirty fluid scraped off the cleaning roller unit 16 is suctioned via the suction fan device 96 and incoupled into the tank device 98 (with air separation).

Otherwise, the surface cleaning machine 94 works in the same way as discussed for the surface cleaning machine 10, and the same components are annotated with the same reference characters.

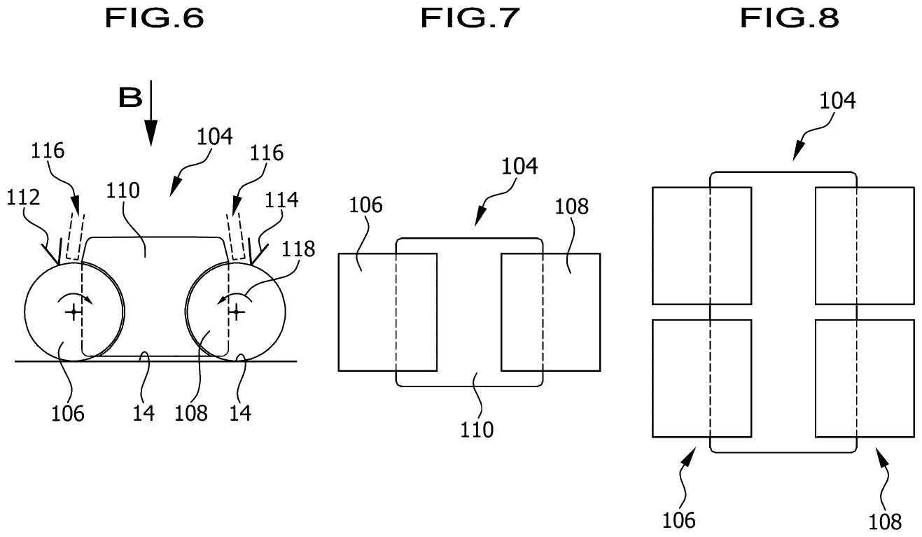

In an exemplary embodiment (FIGS. 6 to 8), a corresponding cleaning head 104 is provided on which are located a first cleaning roller unit 106 and a second cleaning roller unit 108. These are correspondingly driven for rotation about respective axes of rotation, and are driven for rotation in counter-rotational directions in particular.

The first cleaning roller unit 106 and the second cleaning roller unit 108 each have an application chamber 110 associated therewith, wherein the cleaning roller units 106 and 108 have a common application chamber 110 associated therewith.

The application chamber 110 is operatively connected to the hot fluid generating device 26 for fluid communication therewith, and the first cleaning roller unit 106 and the second cleaning roller unit 108 undergo hot fluid application at the application chamber 110.

In an exemplary embodiment, the application chamber 110 is positioned at the cleaning head 104, between the first cleaning roller unit 106 and the second cleaning roller unit 108.

Each cleaning roller unit 106, 108 has associated therewith its own scraper 112, 114 respectively for loosening dirty fluid.

A nozzle device 116 is provided which corresponds to the nozzle device 100 as mentioned above and which, here, suctions dirty fluid from both the first cleaning roller unit 106 and the second cleaning roller unit 108.

In the exemplary embodiment shown in FIG. 6, a direction of rotation 118 of the first cleaning roller unit 106 and the second cleaning roller unit 108 is in each case such that a particular area of the respective cleaning roller unit 106, 108 first undergoes hot fluid application in the application chamber 110, then, on account of the rotation about the axis of rotation in the direction of rotation 118, acts on the surface 14 to be cleaned, and then rotates to the respective scraper 112 and 114 in order enable loosening of dirty fluid.

Otherwise, the corresponding surface cleaning machine comprising the cleaning roller units 106, 108 works as described above.

Here, the cleaning roller units 106, 108 can each be of one-part configuration (FIG. 7) or of multi-part configuration (FIG. 8), and two-part configuration in particular.

A concrete exemplary embodiment of a surface cleaning machine in accordance with the invention is a floor cleaning machine 120 (FIG. 9). The corresponding cleaning head 12 has a base body 122. The cleaning roller unit 16 and the application chamber 34 are located at the base body 122 in the arrangement as has been described in relation to FIGS. 3 and 4. The tank device 24 is removably located at the cleaning head 12 and, here, at the base body 122.

The drive 22 is arranged at the cleaning head 12 and, here, at the base body 122.

The cleaning head 12 is supported on a surface to be cleaned via one or more support rollers 124 in spaced relation to the cleaning roller unit 16.

Arranged at the cleaning head 12 (and at the base body 122) is a holding rod device 126. The holding rod device 126 is arranged and configured such that an operator in a standing posture, standing on the floor to be cleaned, grasping a handle 128 of the holding rod device 126, can guide the surface cleaning machine 120 over the floor 14 to be cleaned.

A housing 130 is arranged at the holding rod device 126. The housing 130 receives the hot fluid generating device 26. The tank device 28 and optionally the tank device 68 are removably arranged at the housing 130.

The holding rod device 126 is articulated to the base body 122 for pivotal movement via a joint 132. A pivot axis 134 is parallel to the axis of rotation 18 of the cleaning roller unit 16.

An operator in a standing posture can clean a floor as the surface 14 to be cleaned via the floor cleaning machine 120.

As has been described above with reference to the surface cleaning machine 10, in operation of the floor cleaning machine 120, hot fluid disinfection of the cleaning roller unit 16 is realized via hot fluid which is provided by the hot fluid generating device 26 and which acts on the cleaning roller unit 16 at the application chamber 34.

In a further exemplary embodiment of a floor cleaning machine which is schematically shown in FIG. 10 and designated therein by 136, a cleaning head 12 is provided which comprises a base body 138. The functional elements are all arranged at the base body 138, namely the hot fluid generating device 26, the tank device 28 (and optionally the tank device 68), the tank device 24 for dirty fluid, the cleaning roller unit 16 and the application chamber 34 as well as the drive 22.

In particular, the floor cleaning machine 136 is configured as a self-propelled and self-steering floor cleaning machine (cleaning robot).

As has been described above, the cleaning roller unit 16 is hot fluid disinfected when in operation.

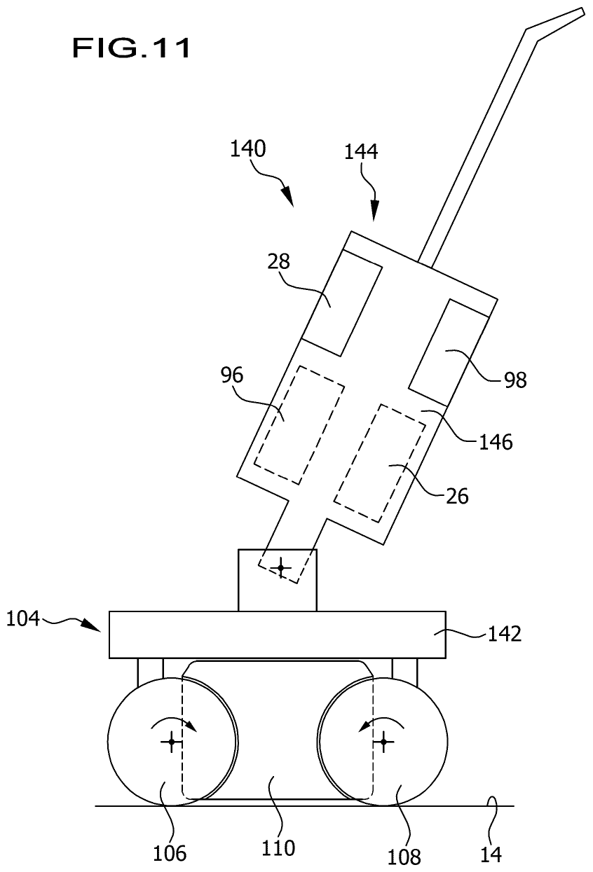

A further exemplary embodiment of a floor cleaning machine in accordance with the invention which is schematically shown in FIG. 11 and designated therein by 140, corresponds to an implementation of the surface cleaning machine 94 of FIG. 2.

A cleaning head 104 is provided which comprises a base body 142. The first cleaning roller unit 106 and the second cleaning roller unit 108 are correspondingly located at the base body 142, having one or more application chambers 110 arranged therebetween.

A holding rod device 144 for an operator in a standing posture is pivotably articulated to the base body 142.

Located at the holding rod device 144 is a housing 146 which receives the suction fan device 96 and the hot fluid generation device 26.

The tank device 98 for dirty fluid (optionally comprising the separator) is removably located at housing 146.

The tank device 28 for water and optionally the tank device 68 for cleaning liquid are removably arranged at the housing 146.

Otherwise, the floor cleaning machine 120 works as described above.

In the solution in accordance with the invention, hot fluid is applied to the cleaning roller unit (for example the cleaning roller unit 16) in the corresponding application chamber, such as the application chamber 34. Thereby, a corresponding area of the cleaning roller unit 16 has hot fluid applied thereto over a relatively long period of time. The application chamber is filled with hot fluid (hot water mist or steam). A high amount of bacteria can then be eliminated at the cleaning roller unit 16. For example, at least 99.99% of bacteria can be eliminated.

The corresponding application chamber, such as the application chamber 34, is an integral part of the corresponding cleaning head 12. For example, it is then also possible to provide for the scraper 78 to be located at the application chamber 34.

### List of Reference Characters

10 surface cleaning machine
12 cleaning head
14 surface
16 cleaning roller unit
18 axis of rotation
20 plane of support
22 drive
24 tank device for dirty fluid
26 hot fluid generating device
28 tank device for water
30 hot fluid generator
32 pump
34 application chamber
36 interior space
38 nozzle device
40 opening
42 partial area
44 direction of immersion
46 effective area
48 wall
50 first longitudinal side
52 second longitudinal side
54 first transverse side
56 second transverse side
58 sealing device
60 length
62 wetting device
64 additional device
66 nozzle device
68 tank device for cleaning liquid
70 conduit device
72 receptacle device for cleaning agent
74 control device
76 energy supply device
78 scraper
80 first partial effective area
82 second partial effective area
84 third partial effective area
86 direction of rotation
88a, 88b part
90 center area
92 forward travel direction
94 surface cleaning machine (second embodiment)
96 suction fan device
98 tank device for dirty fluid
100 nozzle device
102 scraper
104 cleaning head
106 first cleaning roller unit
108 second cleaning roller unit
110 application chamber
112 scraper
114 scraper
116 nozzle device
118 direction of rotation
120 floor cleaning machine
122 base body
124 support roller
126 holding rod device
128 handle
130 housing
132 joint
134 pivot axis
136 floor cleaning machine
138 base body
140 floor cleaning machine
142 base body
144 holding rod device
146 housing

1. A surface cleaning machine, comprising:
a cleaning head;
at least one cleaning roller unit which is rotatably arranged at the cleaning head; and
a drive for driving a rotational movement of the at least one cleaning roller unit;
wherein a hot fluid generating device is provided which, in operation of the surface cleaning machine, generates a hot fluid;
wherein the hot fluid is at least one of hot water with a temperature of at least 80° C. and steam; and
wherein at least one application chamber is provided which is associated with the at least one cleaning roller unit and which is operatively connected to the hot fluid generating device for fluid communication therewith;
wherein, in operation of the surface cleaning machine, an interior space of the at least one application chamber is filled with at least one of hot water mist and steam;
wherein the at least one application chamber has at least one opening; and
wherein the at least one cleaning roller unit is immersed in the interior space of the at least one application chamber at the at least one opening and, in operation of the surface cleaning machine, undergoes application of at least one of hot water mist and steam.

2. The surface cleaning machine in accordance with claim 1, wherein the at least one application chamber is located at the cleaning head.

3. The surface cleaning machine in accordance with claim 1, wherein at least one of the following is provided:
the at least one cleaning roller unit comprises at least one effective area for a surface to be cleaned, which effective area has, as an envelope, a substantially cylindrical outer surface;
at least one area of immersion of the at least one cleaning roller unit into the at least one application chamber has, in cross-section, at least approximately the shape of a section of a circle or segment of a circle;
an axis of rotation of the at least one cleaning roller unit is parallel to a plane of support of the cleaning head on a surface to be cleaned;
the at least one opening has a direction of extent parallel to an axis of rotation of the at least one cleaning roller unit;
a direction of immersion of the at least one cleaning roller unit into the interior space of the at least one application chamber is perpendicular to an axis of rotation of the at least one cleaning roller unit.

4. The surface cleaning machine in accordance with claim 1, wherein, in operation of the surface cleaning machine, at least one of the following is provided:
the application of at least one of hot water mist and steam to the at least one cleaning roller unit is continuous;
a rotational speed of the at least one cleaning roller unit is in a range between 450 revolutions per minute and 500 revolutions per minute;
the application of at least one of hot water mist and steam to the at least one cleaning roller unit is over a range between 10% and 55% relative to a roller circumference;
a time over which a particular roller area of the at least one cleaning roller unit is exposed to the application of at least one of hot water mist and steam is in a range between 0.012 s and 0.06 s;
a temperature of at least one of the hot water mist and the steam is in a range between 75° C. and 90° C. at contact with the at least one cleaning roller unit;
a temperature at the cleaning roller unit is in a range between 55° C. and 75° C. at contact with a surface to be cleaned.

5. The surface cleaning machine in accordance with claim 1, wherein the at least one cleaning roller unit is immersed with a partial effective area of an effective area thereof in the at least one application chamber, wherein the partial effective area is variable on account of rotation of the at least one cleaning roller unit in operation of the surface cleaning machine.

6. The surface cleaning machine in accordance with claim 5, wherein, in operation of the surface cleaning machine, the at least one cleaning roller unit is immersed with a first partial effective area thereof in the at least one application chamber and acts on the surface to be cleaned with a second partial effective area thereof which is in spaced relation to the first partial effective area in a circumferential direction.

7. The surface cleaning machine in accordance with claim 6, wherein, at a third partial effective area of the at least one cleaning roller unit which is in spaced relation to the first partial effective area in the circumferential direction and is in spaced relation to the second partial effective area in the circumferential direction, provision is made for loosening dirty fluid from the at least one cleaning roller unit.

8. The surface cleaning machine in accordance with claim 7, wherein at least one of the following is provided:
the first partial effective area is located between the second partial effective area and the third partial effective area, with respect to a direction of rotation of the at least one cleaning roller unit;
a direction of rotation of the at least one cleaning roller unit is such that, upon rotation of the at least one cleaning roller unit, the first partial effective area transitions to the third partial effective area, or the first partial effective area transitions to the second partial effective area.

9. The surface cleaning machine in accordance with claim 1, wherein, relative to a longitudinal direction parallel to an axis of rotation of the at least one cleaning roller unit, at least 70% of an effective area of the at least one cleaning roller unit is immersed in the at least one application chamber.

10. The surface cleaning machine in accordance with claim 1, wherein at least one of the following is provided:
the at least one application chamber forms an enclosure for a partial area of the at least one cleaning roller unit;
the at least one cleaning roller unit forms a movable cover for the at least one application chamber at the at least one opening;
in a 360° rotation of the at least one cleaning roller unit, an effective area of the at least one cleaning roller unit completes a full pass through the application chamber, with respect to a circumferential direction of the at least one cleaning roller unit.

11. The surface cleaning machine in accordance with claim 1, wherein a sealing device is provided which provides an operative fluid seal between the at least one cleaning roller unit and the at least one application chamber.

12. The surface cleaning machine in accordance with claim 11, wherein at least one of the following is provided:
the sealing device comprises a wall of the at least one application chamber, which wall is in contact against or protrudes into a cleaning substrate of the at least one cleaning roller unit;
the sealing device is arranged or formed at the at least one opening all therearound.

13. The surface cleaning machine in accordance with claim 1, wherein a wall of the at least one application chamber has, at the opening, a first longitudinal side, a second longitudinal side which is opposite the first longitudinal side, a first transverse side, and a second transverse side which is opposite the first transverse side, wherein the first transverse side and the second transverse side are each connected to the first longitudinal side and the second longitudinal side, with at least one of the following:
at least one of the first longitudinal side and the second longitudinal side is oriented parallel to an axis of rotation of the at least one cleaning roller unit;
the first longitudinal side and the second longitudinal side are parallel to one another;
at least one of the first transverse side and the second transverse side is oriented transversely to an axis of rotation of the at least one cleaning roller unit;
the first transverse side and the second transverse side are oriented parallel to one another;
at least one of the first longitudinal side and the second longitudinal side extends in a linear path along an end face thereof;
at least one of the first transverse side and the second transverse side extends in a curvilinear path along an end face thereof.

14. The surface cleaning machine in accordance with claim 1, wherein the at least one application chamber has associated therewith a nozzle device for hot fluid.

15. The surface cleaning machine in accordance with claim 1, wherein a wetting device for wetting the at least one cleaning roller unit with cleaning liquid is provided.

16. The surface cleaning machine in accordance with claim 15, wherein the wetting device comprises the at least one application chamber.

17. The surface cleaning machine in accordance with claim 15, wherein the wetting device comprises at least one of the following:
an additional device, additionally to the at least one application chamber, which applies cleaning liquid to at least one of the at least one cleaning roller unit and a surface to be cleaned;
a tank device for cleaning liquid;
a receptacle device for cleaning agent;
a nozzle device which is oriented towards at least one of the at least one cleaning roller unit and a surface to be cleaned and which is operatively connected to a tank device for cleaning liquid for fluid communication therewith.

18. The surface cleaning machine in accordance with claim 15, wherein, in operation of the surface cleaning machine, upon rotation of the at least one cleaning roller unit, a particular area of the at least one cleaning roller unit (i) first undergoes application of cleaning liquid, is then passed through the at least one application chamber, and, thereafter, acts on the surface to be cleaned, or (ii) undergoes application of cleaning liquid, then acts on the surface to be cleaned, and, thereafter, is passed through the at least one application chamber.

19. The surface cleaning machine in accordance with claim 1, wherein at least one scraper is provided which loosens dirty fluid from the at least one cleaning roller unit.

20. The surface cleaning machine in accordance with claim 19, wherein at least one of the following is provided:
the at least one cleaning roller unit comprises a textile cleaning substrate and the at least one scraper is in contact against the cleaning substrate or protrudes into the cleaning substrate;
the at least one scraper is arranged or formed at the at least one application chamber;
the at least one scraper is configured as a scraper strip.

21. The surface cleaning machine in accordance with claim 19, wherein the at least one scraper is arranged, relative to a direction of rotation of the at least one cleaning roller unit, in such a way that (i) in operation of the surface cleaning machine, a particular area of the at least one cleaning roller unit first acts on the surface to be cleaned, then passes through the at least one application chamber, and, thereafter, rotates past the at least one scraper, or (ii) the particular area of the at least one cleaning roller unit is first passed through the application chamber, then acts on the surface to be cleaned, and is then passed past the at least one scraper.

22. The surface cleaning machine in accordance with claim 1, wherein at least one tank device for dirty fluid is provided.

23. The surface cleaning machine in accordance with claim 22, wherein at least one of the following is provided:
the at least one tank device for dirty fluid is arranged at the cleaning head;
the at least one tank device for dirty fluid is removably arranged at the cleaning head;
dirty fluid is conveyed from the at least one cleaning roller unit to the at least one tank device for dirty fluid without using a fan or pump.

24. The surface cleaning machine in accordance with claim 22, wherein at least one of (i) a suction fan device comprising a suction fan which conveys dirty fluid from the at least one cleaning roller unit to the tank device for dirty fluid and (ii) a pump device comprising a pump which conveys dirty fluid from the at least one cleaning roller unit to the tank device for dirty fluid is provided.

25. The surface cleaning machine in accordance with claim 1, wherein the surface cleaning machine is configured as a machine that can be guided by an operator in a standing posture, comprising a holding rod device which is arranged at the cleaning head.

26. The surface cleaning machine in accordance with claim 25, wherein at least one of the following is provided:
the hot fluid generating device is arranged at the holding rod device;
a tank device for the hot fluid generating device is arranged at the holding rod device;
a tank device for cleaning liquid is arranged at the holding rod device;
at least one of a suction fan device for dirty fluid and a pump device for dirty fluid is arranged at the holding rod device.

27. The surface cleaning machine in accordance with claim 1, wherein the surface cleaning machine is configured as a self-propelled and self-steering machine.

28. The surface cleaning machine in accordance with claim 1, wherein the hot fluid generating device and the drive are arranged at the cleaning head.

29. The surface cleaning machine in accordance with claim 1, wherein the hot fluid generating device comprises a hot fluid generator and a pump.

30. The surface cleaning machine in accordance with claim 1, wherein the hot fluid generating device has associated therewith a tank device for water.

31. The surface cleaning machine in accordance with claim 30, wherein a wetting device for applying cleaning liquid to at least one of the at least one cleaning roller unit and the surface to be cleaned has associated therewith a tank device for cleaning liquid of its own, or the hot fluid generating device and the wetting device have associated therewith a tank device for water which is common to both.

32. The surface cleaning machine in accordance with claim 1, wherein the at least one cleaning roller unit is of one-part or multi-part configuration.

33. The surface cleaning machine in accordance with claim 1, wherein exactly one cleaning roller unit or a plurality of cleaning roller units are arranged at the cleaning head.

34. The surface cleaning machine in accordance with claim 33, wherein the at least one application chamber is arranged at the cleaning head, between a first cleaning roller unit and a second cleaning roller unit.

35. The surface cleaning machine in accordance with claim 1, wherein the cleaning head has a front end, relative to a forward travel direction of the surface cleaning machine, and wherein the at least one application chamber is arranged at the front end.

36. The surface cleaning machine in accordance with claim 1, wherein the at least one cleaning roller unit is arranged at the cleaning head, between the at least one application chamber and a tank device for dirty fluid.

37. A method for operating a surface cleaning machine in which, in a cleaning mode of operation, a cleaning roller unit acts in rotation on a surface to be cleaned, said surface cleaning machine comprising:
a cleaning head;
at least one cleaning roller unit which is rotatably arranged at the cleaning head;
a drive for driving a rotational movement of the at least one cleaning roller unit;
wherein a hot fluid generating device is provided which, in operation of the surface cleaning machine, generates a hot fluid;
wherein the hot fluid is at least one of hot water with a temperature of at least 80° C. and steam; and
wherein at least one application chamber is provided which is associated with the at least one cleaning roller unit and which is operatively connected to the hot fluid generating device for fluid communication therewith;
wherein, in operation of the surface cleaning machine, an interior space of the at least one application chamber is filled with at least one of hot water mist and steam;
wherein the at least one application chamber has at least one opening; and
wherein the at least one cleaning roller unit is immersed in the interior space of the at least one application chamber at the at least one opening and, in operation of the surface cleaning machine, undergoes application of at least one of hot water mist and steam,
the method comprising:
passing the cleaning roller unit through an application chamber to which hot water mist or steam is applied.

38. The method in accordance with claim 37, wherein, in operation of the surface cleaning machine, at least one of the following is provided:
the application of at least one of hot water mist and steam to the at least one cleaning roller unit is continuous;
a rotational speed of the at least one cleaning roller unit is in a range between 450 revolutions per minute and 500 revolutions per minute;
the application of at least one of hot water mist and steam to the at least one cleaning roller unit is over a range between 10% and 55% relative to a roller circumference;
a time over which a particular roller area of the at least one cleaning roller unit is exposed to the application of at least one of hot water mist and steam is in a range between 0.012 s and 0.06 s;
a temperature of at least one of the hot water mist and the steam is in a range between 75° C. and 90° C. at contact with the at least one cleaning roller unit;
a temperature at the cleaning roller unit is in a range between 55° C. and 75° C. at contact with a surface to be cleaned.

39. The method in accordance with claim 37, wherein a first partial effective area of the cleaning roller unit is positioned in the application chamber when a second partial effective area of the cleaning roller unit acts on the surface to be cleaned, wherein the second partial effective area is in spaced relation to the first partial effective area in a circumferential direction.

40. The method in accordance with claim 37, wherein, at a third partial effective area of the cleaning roller unit, dirty fluid is loosened from the cleaning roller unit, wherein the third partial effective area is in spaced relation to the first partial effective area in the circumferential direction and is in spaced relation to the second partial effective area in the circumferential direction.

41. The method in accordance with claim 37, wherein the cleaning roller unit rotates in a direction of rotation such that a particular area of the cleaning roller unit is first passed through the application chamber, then acts on the surface to be cleaned, and, thereafter, loosening of dirty fluid is realized at the particular area.

42. The method in accordance with claim 37, wherein the cleaning roller unit rotates in a direction of rotation such that a particular area of the cleaning roller unit first acts on the surface to be cleaned, is then passed through the application chamber, and, thereafter, loosening of dirty fluid is realized at the particular area.

43. The method in accordance with claim 37, wherein the cleaning roller unit is wetted, wherein the wetting is realized in the application chamber by use of at least one of hot water fluid and steam.

44. The method in accordance with claim 37, wherein the application chamber is replenished with hot fluid.
